(19) United States
(12) Patent Application Publication
(10) Pub. No.: US 2017/0168166 A1
(43) Pub. Date: Jun. 15, 2017

(54) HYBRID X-RAY DETECTORS IMPLEMENTED BY MEANS OF SOFT SINTERING OF TWO OR MORE INTERMIXED POWDERS

(71) Applicant: Siemens Healthcare GmbH, Erlangen (DE)

(72) Inventors: Rene FISCHER, Erlangen (DE); Andreas KANITZ, Hoechstadt (DE); Oliver SCHMIDT, Erlangen (DE); Sabine SZYSZKOWSKI, Dachsbach (DE); Sandro Francesco TEDDE, Weisendorf (DE)

(73) Assignee: Siemens Healthcare GmbH, Erlangen (DE)

(21) Appl. No.: 15/362,855

(22) Filed: Nov. 29, 2016

(30) Foreign Application Priority Data
Dec. 14, 2015 (DE) 102015225134.9

(51) Int. Cl. G01T 1/20; B05D 3/12; C09K 11/02; B05D 3/00

(52) U.S. Cl. CPC G01T 1/2018; B05D 3/007; B05D 3/12; C09K 11/025

(57) ABSTRACT

A powder mixture is disclosed. In an example embodiment, the powder mixture includes at least one organic semiconductor material and at least one first scintillator. A method for the production of a powder mixture includes at least one organic semiconductor material and at least one first scintillator. A method for the production of a detector using the powder mixture and a detector produced by way of this method are also disclosed.

### PRIORITY STATEMENT

The present application hereby claims priority under 35 U.S.C. §119 to German patent application number DE 102015225134.9 filed Dec. 14, 2015, the entire contents of which are hereby incorporated herein by reference.

### FIELD

At least one embodiment of the invention generally relates to a powder mixture comprising at least one organic semiconductor material and at least one first scintillator, a method for the production of a powder mixture comprising at least one organic semiconductor material and at least one first scintillator, a method for the production of a detector using the powder mixture and/or a detector produced by the method.

### BACKGROUND

Nowadays, digital X-ray images are preferably recorded with indirect converters comprising, for example, a CsI scintillator coating, which is applied to an a-Si photodetector matrix. Alternatively, direct converters, such as, for example, a-Se are also used, particularly in applications requiring high resolution, such as mammography.

Hence, the present prior art is represented by detectors based on amorphous silicon (indirect conversion) and amorphous selenium (direct conversion). The principles of direct conversion are shown in FIG. 1 and the principles of indirect conversion are shown in FIG. 2. In the case of direct conversion, an X-ray quantum 1 is absorbed in the semiconductor 2, wherein electron-hole pairs 2a, 2b are generated which then migrate to the electrodes 4 (anode or cathode, for example pixel electrodes) where they are detected. In the case of indirect conversion, the X-ray quantum 1 is absorbed in the scintillator 2 which in turn emits radiation 2′ with low energy (for example visible light, UV or IR radiation), which is then detected via a photodetector 3 (for example a photodiode).

Therefore, indirect X-ray conversion involves, for example, the combination of a scintillator coating (for example Gd₂O₂S or CsI with different doping materials such as terbium, thallium, europium, etc.; layer thicknesses typically 0.1-1 mm) and a photodetector (preferably a photodiode). In this case, the emission wavelength of the scintillator light by way of X-ray conversion overlaps the spectral sensitivity of the photodetector.

In the case of direct X-ray conversion, the X-rays are, for example, again converted directly into electron/hole pairs, which are read-out electronically (for example amorphous Se). Direct X-ray conversion in selenium is usually performed with layers with a thickness of up to 1 mm, which are pretensioned in the kV range. While indirectly converting detectors have become established in particular in because they are simple and inexpensive to produce, direct converters generally have much better resolving power.

Hybrid-organic X-ray detectors are potential replacements for existing X-ray detector concepts (for example indirect conversion concepts—CsI to a:Si or direct converters from a:Se).

Scintillators are embedded in an organic semiconductor matrix, X-rays are absorbed in the scintillator and the re-emitted visible light is absorbed by the organic semiconductor matrix and converted into electron-hole pairs. The charges are driven by an electric field applied from the exterior and transported to the contacts where they are detected.

Nowadays, organic semiconductors are primarily applied from the liquid phase or applied by vapor deposition under vacuum. To this end, methods used to date for mixing in inorganic absorber material usually use processing from the liquid phase.

To achieve sufficiently high X-ray detection, the detection coatings should be very thick, typically 100-500 μm. Such thicknesses can, for example, be achieved by powder sintering.

In this context, previous concepts for the soft sintering of powders for the production of X-ray detectors are in each case based on core-shell particles, with which the core comprises a scintillator particle and the shell comprises organic semiconductors in the form of BHJ. Such core-shell powders can be produced via precipitation.

DE 101 37 012 A1 discloses an embodiment of a light-sensitive and polymeric absorber layer with embedded scintillator granules. The conductivity of the polymeric layers is increased by the absorption of light from the scintillator. The mean distance of the scintillator granules in the coating corresponds to the mean free path length of the photons from the scintillator in the polymer.

DE 10 2010 043 749 A1 describes an X-ray detector, wherein scintillators are either directly dispersed into the organic semiconductor solution or sprayed on in a “co-spraying process” at the same time as the organic semiconductor material.

In addition, DE 10 2014 212 424 discloses scintillators with an organic photodetection shell and DE 10 2013 226 365 hybrid-organic X-ray detectors with conductive channels. It is also possible to derive a photoelectric intensifying screen from WO2015/091145.

DE 10 2014 225 543 also describes perovskite particles with an organic covering for the production of X-ray detectors via deposition from the dry phase.

Hybrid detectors can also be derived from U.S. Pat. No. 8,759,781 B2, although the production method is not described here.

There is a requirement for simple production methods for detectors, in particular X-ray detectors, with which, in particular according to certain embodiments, it is also possible to achieve high concentrations of scintillators in the detector.

### SUMMARY

The inventors have identified that, instead of a complex core-shell particle production process, it is possible to use a simple process with which the individual starting materials are present in the form of particulate powder and these are then mixed before a compaction method, such as, for example, soft sintering is used to form the final detection coating, for example an X-ray conversion coating.

With the mixing method of an embodiment, it is in particular possible to introduce any concentrations of scintillators, such as GOS, in a detection coating, for example a hybrid coating. In this case, the mixing of the individual starting materials in particulate form (powders) in particular enable much higher scintillator concentrations to be achieved in a detection coating, which has a positive effect on the X-ray absorption of the hybrid coating. A higher concentration of scintillator particles in an absorption coating for the detection of radiation, in particular X-rays, enables higher absorption with the same layer thickness, for example X-ray absorption. This enables the layer thicknesses of the detection coating in detectors to be made thinner in order to ensure the same absorption as that in previous detectors with lower concentrations of scintillators. Thinner absorption layers have the advantage that lower operating voltages are required and at the same time the part to traversed by the charge carriers to the electrodes can be reduced, for example by reducing the transit time and reducing the charge carrier combination so that quicker detectors with increased efficiency are possible.

According to a first embodiment, the present invention relates to a powder mixture, comprising at least one organic semiconductor material and at least one first scintillator.

In a further embodiment, the invention relates to a method for the production of a powder mixture comprising at least one organic semiconductor material and at least one scintillator comprising the provision of at least one powder comprising at least one organic semiconductor material, the provision of at least one powder comprising at least one first scintillator, and the intermixing of the powders.

An embodiment of the invention is also directed toward a method for the production of a detector, in particular an X-ray detector, comprising the provision of a substrate comprising a first electrode, optionally the application of a first intermediate coating, the application of the powder mixture according to the invention, optionally the application of a second intermediate coating and the application of a second electrode, wherein the powder mixture according to the invention, optionally with the first intermediate coating and/or the second intermediate coating and/or the second electrode, is compacted, in particular sintered.

An embodiment of the invention is also directed toward a detector produced by way of the method according to an embodiment of the invention for the production of a detector, in particular an X-ray detector.

Further embodiments of the present invention can be derived from the claims and the detailed description.

### BRIEF DESCRIPTION OF THE DRAWINGS

The attached drawing are intended to illustrate embodiments of the present invention and provide a better understanding thereof. In conjunction with the description, they serve to explain concepts and principles of the invention. Other embodiments and many of the advantages named may be derived with reference to the drawings. The elements are not necessarily shown true to scale with respect to one another. Unless stated otherwise, elements, features and components that are identical or have identical functions are in each case given the same reference number in the figures in the drawings.

FIGS. 1 and 2 are schematic comparisons of the concepts of direct X-ray conversion (FIG. 1) and indirect X-ray conversion (FIG. 2).

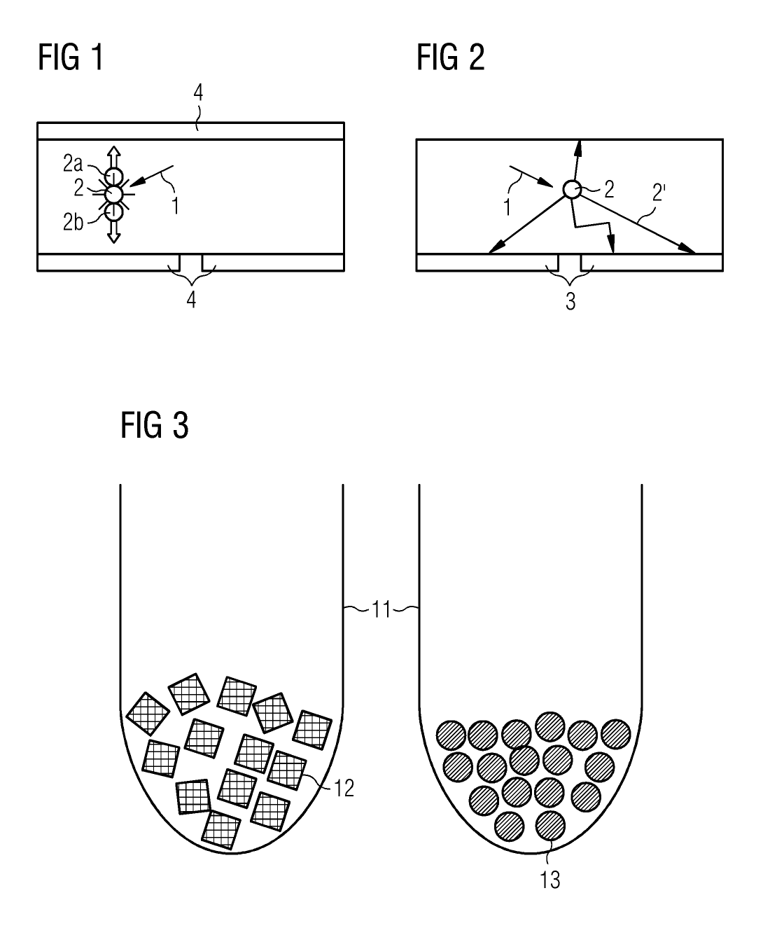

FIG. 3 is a schematic depiction of a scintillator powder and a semiconductor powder before mixing as example starting materials of a powder mixture according to an embodiment of the invention.

FIG. 4 is an example schematic depiction of a powder mixture obtained by adding the scintillator powder to the semiconductor powder from FIG. 3 before mixing and FIG. 5 shows a powder mixture according to an embodiment of the invention after the intermixing, for example by way of speed mixing.

FIG. 6 is an example schematic depiction of the coating structure of a detector according to an embodiment of the invention in the form of an X-ray detector comprising a sintered hybrid powder in the detection coating.

A further example schematic depiction of the coating structure of a detector according to an embodiment of the invention in the form of an X-ray detector with intermediate layers can be derived from FIG. 7.

In addition, FIGS. 8 and 9 show current-voltage characteristics (FIG. 8) and conversion rates (FIG. 9) of example X-ray detectors according to an embodiment of the invention which were produced using mixed powders.

### DETAILED DESCRIPTION OF THE EXAMPLE EMBODIMENTS

For the purposes of an embodiment of the invention, gamma radiation and X-rays are radiation in an energy range of from 1 keV to 5 MeV (1.24 nm to 0.25 pm). Both types of radiation are ionizing radiation, wherein the origin of X-rays is in the electron shells, for example as the result of transitions and deceleration, while gamma radiation is formed by nuclear processes, for example by decay/fusion. In this case, the energy ranges of the two types of radiation can overlap. According to certain embodiments, X-rays include the range of from 1 keV to 250 keV (1.24 nm-5 pm). According to certain embodiments, X-rays are detected, i.e. a detector for X-rays or a method for the production thereof is disclosed.

According to a first embodiment, the present invention relates to a powder mixture, in particular for the production of detectors, for example X-ray detectors, comprising at least one organic semiconductor material and at least one first scintillator.

According to certain embodiments, the present invention relates to a powder mixture, in particular for the production of detectors, for example X-ray detectors comprising at least one organic semiconductor material and one first scintillator. According to certain embodiments, the powder mixture comprises a first scintillator powder and powders of one or two organic semiconductor materials.

In this context, the nature of the mixing is not particularly restricted, but, according to certain embodiments, a homogeneous mixture is present.

In this case, the first scintillator is not particularly restricted and, according to certain embodiments, is present as a powder or a plurality of particles. Neither is it excluded according to an embodiment of the invention that more than one scintillator is present in the powder mixture, i.e. for example two, three, four or more scintillators made of different materials. The scintillators can also be present as particles with different particle sizes, for example to achieve denser packing of the particles, wherein scintillator particles of different sizes can consist of the same material or different materials.

Possible scintillator materials include the following materials: gadolinium oxysulfide (GOS), cesium iodide (CsI), sodium iodide (NaI), yttrium oxide (Y2O3), yttrium aluminum garnet (YAG), gadolinium gallium aluminum garnet (GGAG), lutetium oxyorthosilicate (LSO), cadmium iodide (CdI₂), lutetium oxide (Lu₂O₃), bismuth germanate (BGO), zinc sulfide (ZnS), cadmium tungstate (CdWO₄ or CWO), lutetium yttrium oxyorthosilicate (LYOS), gadolinium oxyorthosilicate (Gd₂SiO₅ or GSO), yttrium gadolinium oxide (YGdO), gadolinium gallium oxide (GdGaO) and/or mixtures thereof. GOS and Y₂O₃ are preferred.

In this case, according to certain embodiments, the scintillator, for example the scintillator particles, are doped with at least one of the following substances: terbium (Tb), europium (Eu), praseodym (Pr), lithium (Li), thallium (Tl), cerium (Ce), fluorine (F), lutetium (Lu). Tb and Eu are preferred.

Preferred scintillators are Gd₂O₂S:Tb and Y₂O₃:Eu.

According to certain embodiments, the scintillators, i.e. a first and/or a further, for example second scintillator, in particular the scintillator particles, are coated with an additional protective coating, in particular an oxide and/or nitride coating. In this case, a protective coating such as an oxide coating and/or nitride coating comprises a material, that renders the scintillator, for example the scintillator particles, substantially inert or inert to the organic semiconductor material or materials or the organic semiconductors, for example an oxide and/or nitride or even an oxynitride, etc. Preferred protective coatings comprise or consist of aluminum oxide (Al₂O₃), silicon oxide (SiO₂), silicon nitride (Si₃N₄), zirconium oxide (ZrO₂), tin oxide (SnO₂), zinc oxide (ZnO), and/or mixtures thereof, wherein the protective coating preferably coats the scintillator, i.e. for example substantially all the scintillator particles, by more than 50%, preferably more than 80%, more preferably by more than 90%, still more preferably by more than 95%, in particular by 100%, based on the surface of the scintillator or the scintillator particles. Al₂O₃ and/or SiO₂ are preferable as the protective coating.

The organic semiconductor material, hereinafter also referred to as the organic matrix, is not particularly restricted and can for example comprise or consist of at least one photoactive material.

According to certain embodiments, the organic semiconductor material comprises or consists of an electron conductor and/or hole conductor, for example PCBM and/or P3HT.

Possible organic semiconductor materials include inter alia the following materials:

As hole conductors: poly(3-hexylthiophene-2,5-diyl) (P3HT), poly[2-methoxy-5-(2-ethylhexyloxy)-1,4-phenylenvinylen] (MEH-PPV), Poly[2-methoxy-5-(3′,7′-dimethyloctyloxy)-1,4-phenylenvinylene] (MDMO-PPV), poly[(9,9-di-n-octylfluorenyl-2,7-diyl)-alt-(benzo[2,1,3]thiadiazole-4,8-diyl)] (F8BT), or other polyfluorene (PFO) polymers and/or copolymers, poly[2,1,3-benzothiadiazole-4,7-diyl[4,4-bis(2-ethylhexyl)-4H-cyclopenta[2,1-b:3,4-b′]dithiophene-2,6-diyl]] (PCPDTBT), squaraines such as, for example, hydrazone end-capped symmetrical squaraines with glyclolic functionalization (hydrazone end-capped symmetric squaraines with glycolic functionalization) or diazulene squaraines, polythieno[3,4-b]thiophene (PTT), Poly(5,7-bis4-decanyl-2-thienyl)-thieno(3,4-b)diathiazolthiophen-2,5) PDDTT, diketoopyrrolopyrrole (DPP) derivatives and/or mixtures thereof.

As electron conductors: fullerenes such as C₆₀, C₇₀, C₇₆, C₈₀, C₈₂, C₈₄, C₈₆, C₉₀ and C₉₄, fullerene derivatives such as [6,6]-phenyl-C61-butyric acid methyl ester ([60]PCBM), [6,6]-phenyl-C71-butyric acid methyl ester ([70]PCBM), bis-[6,6]-phenyl-C61-butyric acid methyl ester (bis-[60]PCBM), bis-[6,6]-phenyl-C71-butyric acid methyl ester (bis-[70]PCBM), mono-(o-quinodimethane)-C60, bis-(o-quinodimethane)-C60 (mixture of isomers), C60(OH)_{24/26} hydroxylated, [1,4]methanonaphtho[2′,3′:1,9][5,6]fullerene-C60-Ih, 1′,4′-dihydro[5,6]fullerene-C60-Ih, tetrahydro-bis(2,3-dihydro-1H-indene-1,3-diyl) derivative; graphene flakes, single-walled carbon nanotubes (SWCNT), multi-walled carbon nanotubes, (MWCNT) and/or mixtures thereof.

According to certain embodiments, the organic semiconductor material is present in the form of a donor/acceptor mixture comprising or consisting of at least 2 organic semiconductors

In this case, the donor/acceptor mixture is also called a bulk heterojunction. Therefore, according to certain embodiments, the organic semiconductor material forms a bulk heterojunction. Therefore, according to certain embodiments, the organic semiconductor material is a mixture of an electron conductor and a hole conductor, for example PCBM and P3HT forming a bulk heterojunction. The mixing ratio—as a percentage by weight based on the bulk heterojunction—is not particularly restricted and can be set in dependence upon the materials used, for example with a ratio of 8:1 to 1:8, preferably 4:1 to 1:4, more preferably 2:1 to 1:2, for example 1:1. In addition, to the example BHJs with two organic semiconductor materials, i.e. binary, BHJs, BHJs with more organic semiconductor materials, i.e., for example, ternary BHJs with three organic semiconductor materials, etc., are also conceivable.

A typical representative of a strong electron donor (low electron affinity) is, for example, the conjugated polymer poly-3-hexylthiophene) (P3HT). Typical materials for electron acceptors (high electron affinity) are fullerenes and the derivatives thereof such as, for example, [6,6]-phenyl-C61-butyric acid methyl ester (PCBM). However, it also possible to use materials such as polyphenylene vinylene and derivatives thereof such as the cyano derivative CN-PPV, MEH-PPV (poly(2-(2-ethylhexyloxy)-5-methoxy-p-phenylenvinylene)), CN-MEH-PPV or phthalocyanine, etc. Further example compounds are mentioned below in combination with suitable scintillator particles.

According to certain embodiments, the material of the organic matrix absorbs radiation in a wavelength range in which the scintillator particles emit radiation. In addition, according to certain embodiments, the photoactive material of the organic matrix also has at least one absorption peak at a wavelength corresponding to an emission wavelength of the scintillator particle, preferably the emission wavelength of an emission peak of the scintillator particle.

Example material combinations for a combination of scintillator particles with photoactive organic materials for different wavelengths are described below:

Suitable green scintillators are for example Gd2O2S:Pr,Ce (gadolinium oxysulfide, doped with praseodymium and cerium with an emission peak at approximately 515 nm), Gd2O2S:Tb (gadolinium oxysulfide, doped with terbium with an emission peak at approximately 545 nm), Gd2O2S:Pr,Ce,F (gadolinium oxysulfide, doped with praseodymium or cerium or fluorine with an emission peak at approximately 510 nm), YAG:Ce (yttrium aluminum garnet doped with cerium with an emission peak at approximately 550 nm), CsI:Tl (cesium iodide, doped with thallium with an emission peak at approximately 525 nm), CdI2:Eu (europium-doped cadmium iodide with an emission peak at approximately 580 nm) or Lu2O3:Tb (lutetium oxide doped with terbium with an emission peak at approximately 545 nm), are characterized by an emission peak in the range of 515-580 nm and are well adapted for the absorption peak for poly(3-hexylthiophene-2,5-diyl) (P3HT) (as an example photoactive material in the organic matrix) at 550 nm. The scintillator Bi4Ge3O12 or BGO (bismuth germanate with an emission peak at approximately 480 nm) can be combined effectively with poly[2-methoxy-5-(2-ethylhexyloxy)-1,4-phenylenvinylene] (MEH-PPV) or poly[2-methoxy-5-(3′,7′-dimethyloctyloxy)-1,4-phenylenvinylene] (MDMO-PPV) which have good absorption in the range 460-520 nm.

Suitable blue scintillators should also be named. One attractive combination of material with emission in the blue range is Lu₂SiO₅:Ce or LSO (cesium-doped lutetium oxyorthosilicate with an emission peak at approximately 420 nm), Lu_{1.8}Y_{0.2}SiO₅:Ce (with cerium-doped lutetium oxyorthosilicate with an emission peak at approximately 420 nm), CdWO₄ (cadmium tungstate with an emission peak at approximately 475 nm), CsI:Na (cesium iodide doped with sodium with an emission peak at approximately 420 nm), or NaI:Tl (thallium-doped sodium iodide with an emission peak at approximately 415 nm), Bi₄Ge₃O₁₂ or BGO (bismuth germanate with an emission peak at approximately 480 nm), Gd₂SiO₅ or GSO (gadolinium oxyorthosilicate doped with cerium with an emission peak at approximately 440 nm), or CsBr:Eu (cesium bromide doped with europium with an emission peak at approximately 445 nm), which are combined effectively with typical wide-band gap semiconductors such as poly[(9,9-di-n-octylfluorenyl-2,7-diyl)-alt-(benzo[2,1,3]thiadiazole-4,8-diyl)] (F8BT) (absorption peak at 460 nm) or other polyfluorene (PFO) polymers and copolymers (absorption at 380-460 nm).

Red scintillators such as Lu₂O₃:Eu (lutetium oxide doped with europium with an emission peak at approximately 610-625 nm), Lu₂O₃:Tb (lutetium oxide doped with terbium with an emission peak at approximately 610-625 nm) or Gd₂O₃:Eu (gadolinium oxysulfide doped with europium with an emission peak at approximately 610-625 nm), YGdO:(Eu,Pr) (europium and/or praseodymium-doped yttrium gadolinium oxide with an emission peak at approximately 610 nm), GdGaO:Cr,Ce (chromium and (or cesium-doped gadolinium gallium oxide), or CuI (copper iodide with an emission peak at approximately 720 nm) can be effectively combined with absorbers, such as those developed for OPV (organic photovoltaics), for example poly[2,1,3-benzothiadiazole-4,7-diyl[4,4-bis(2-ethylhexyl)-4H-cyclopenta[2,1-b:3,4-b′]dithiophene-2,6-diyl]] (PCPDTBT), squaraines (for example hydrazone end-capped symmetrical squaraines with glycolic functionalization or diazulene squaraines), polythieno[3,4-b]thiophene (PTT), poly(5,7-bis(4-decanyl-2-thienyl)-thieno(3,4-b)diathiazol-thiophene-2,5) (PDDTT).

According to preferred embodiments of these pairs, the following should be particularly highlighted: Gd2O2S:Tb or YAG:Ce in combination with P3HT:PCBM, Lu2SiO5:Ce in combination with F8BT or YGdO:Eu with PCPDTBT.

According to certain embodiments, the first scintillator is present in the form of first scintillator particles. According to certain embodiments, the powder mixture comprises first scintillator particles and optionally further scintillator particles with an average particle size of 0.5 to 50 μm, preferably 1 to 20 μm, more preferably 1.8 to 10 μm, and preferably consists thereof. In this case, scintillator particles can nowadays generally be obtained on a commercial basis as particles with any diameters, for example in the range of from 1 μm to 100 μm, in the quantities of several tonnes.

According to certain embodiments, the organic semiconductor material is present in the form of particles of the organic semiconductor material or mixtures of particles of the organic semiconductor material, in particular a bulk heterojunction. According to certain embodiments, the organic semiconductor material is produced by way of precipitation or spray-drying, in particular in the form of particles. Other common production methods for particles are not excluded. According to certain embodiments, the organic semiconductor material is present as an organic semiconductor mixture, which for example can be obtained by way of precipitation or spray drying, and is preferably present as a particulate powder.

According to certain embodiments, the organic semiconductor material, in particular material which forms a bulk heterojunction, comprises particles with an average particle size of 0.5 to 500 μm, preferably 0.8 to 50 μm, more preferably 1 to 50 μm, even more preferably 1 to 30 μm, and preferably consists thereof. Suitable setting of the particle size can, for example, also be ensured by granulation processes following the production of particles, which are not particularly restricted.

In this case, the diameters of the scintillator particles and the particles of the organic semiconductor material can be suitably determined and hence set by way of optical (for example dynamic light scattering, DLS), electron-microscopy or electrical analytical methods (for example Coulter Counter). Generally, a reduction in the diameter of the particles is accompanied by a reduction in emission strength. According to certain embodiments, the scintillator particles and the particles of the organic semiconductor material are substantially present in spherical form, for example, spherical particles.

Producing the individual starting materials as powder makes the production of detection coatings or detectors much simpler and less expensive compared to the production and use of core-shell particles.

According to certain embodiments, the weight ratio of organic semiconductor material to the first scintillator, based on the powder mixture and/or a detection coating in a detector, lies within a range of 2:1 to 1:32, preferably within a range of more than 1:4 to 1:32, more preferably within a range of more than 1:8 to 1:32, for example more than 1:8 to 1:24 or more than 1:8 to 1:12. In particular, powder mixtures with a high content of scintillator enable detectors with a high scintillator content, which can result in a good, if not better, response of the detector to radiation, for example gamma radiation and/or X-rays, for example X-rays, possibly also with a lower layer thickness of the detection coating. The precipitation of core-shell particles usually only enables weight ratios of up to 1:4, possibly by way of further auxiliary measures such as ultrasonic treatment up to a maximum of 1:8, based on the core-shell particles and/or the detection coating in a detector comprising such core-shell particles.

When a bulk heterojunction (BHJ) is used as organic semiconductor material, it is correspondingly conceivable to have, for example, weight concentrations of 1:1:1 to 1:1:72 (part by weight of organic n-semiconductors, part by weight of organic p-semiconductors and part by weight of scintillators), wherein the other weight ratios can be calculated accordingly. In this case, according to certain embodiments, it should be ensured that the volume content of scintillator, for example GOS, is not greater than the maximum packing density, for example ˜74 vol %, assumed for example for perfect spheres with the same volume, wherein according to certain embodiments, however, there is no perfect spherical form for the particles, for example the scintillator particles. High packing densities can be achieved for particles with different particle sizes.

Correspondingly, in the case of the precipitation method with core-shell particles with BHJs, it is not possible to disperse an arbitrary amount of scintillator particles so that, for example, a maximum concentration of 1:1:16 (1 part by weight of organic n-semiconductor, 1 part by weight of organic p-semiconductor and 16 parts by weight of scintillator particles) can be achieved. It was determined from spray tests that weight ratios of 1:1:24 or higher concentrations of up to 1:1:48 of the scintillator can also demonstrate high, or even better, X-ray responses.

According to certain embodiments, the powder mixture according to the invention—and hence also a detection coating in a detector according to the invention—further comprises a second scintillator—or even more, wherein the second scintillator has an average particle size smaller than the average particle size of the first scintillator. Furthermore, powder or particles from more than two organic semiconductor materials can be present in the powder mixture and hence in the detection coating of the detector.

In addition, according to certain embodiments, the powder mixture according to the invention and/or the detection coating of the detector, which is formed by the powder mixture, can also contain additives such as diiodooctane for improving efficiency or crosslinkers such as bifunctional or multifunctional oxirane or oxetane derivatives (so-called monomeric liquid network formers) in order to improve the electrical and/or mechanical efficiency. According to certain embodiments, the powder mixture according to the invention and/or the detection coating, which is formed from this powder mixture in the detector, does not contain any additives.

According to a further embodiment, the present invention relates to a method for the production of a powder mixture comprising at least one organic semiconductor material and at least one first scintillator, in particular a method for the production of the powder mixture according to the invention comprising:

provision of at least one powder comprising at least the organic semiconductor material;

provision of at least one powder comprising at least one first scintillator; and

intermixing the powder.

In this case, it is possible, for example, before the intermixing, for the powder comprising at least one organic semiconductor material to be added to the powder comprising at least one first scintillator or the powder comprising at least one first scintillator to be added to the powder comprising at least one organic semiconductor material. If more than one scintillator and/or more than one organic semiconductor material is present in the powder mixture, the components can each be added individually and intermixing performed after each addition or all components added to each other then intermixed or individual components, such as, for example, powders of organic semiconductor material which form a BHJ, or several scintillator powders premixed individually and then these premixes added to one another and mixed. If additives are added, they can also be used as suitable and mixed-in in a premix, mixed individually or intermixed in a total mixture. The addition of the individual components to one another is not particularly restricted and can be performed as suitable.

The intermixing of the powders, for example two powders, is not particularly restricted. It can, for example, take place by way of mixing methods with and without contact, for example speed mixing, vibration, rotation or vibration, ultrasound, etc. In this case, the mixing speed is not particularly restricted and can, for example, be determined by the particle sizes and/or shapes of the individual powders. In this case, the intermixing can, for example, be performed with mixing speeds of 10000 rpm or less, preferably 5000 rpm or less, more preferably 3000 rpm or less, for example in a speed mixer, or with equivalent speeds by way of other methods. In this case, the mixing can be performed in an inert atmosphere, comprising one or more inert gases, which are not particularly restricted.

According to certain embodiments, the powders, for example the two starting powders made of organic semiconductor material, and the scintillator, or first scintillator, are intermixed via contactless speed mixers.

According to certain embodiments, before the intermixing, the powder comprising at least one organic semiconductor material and/or the powder comprising at least one first scintillator—and/or optionally further powders—are cooled in an inert gas to a temperature of 0° C. or lower, preferably −10° C. or lower, more preferably −15° C. or lower, for example to −20° C. or lower, for example −20° C. The low temperatures enable the formation of lumps, in particular in the organic semiconductor materials, to be avoided.

According to certain embodiments, the intermixing is performed for a period of less than 120 s, preferably less than 60 s, more preferably less than 45 s, in particular preferably 30 s or less, in order to achieve optimum intermixing. For example, speed mixing can be performed after precooling for 15 min at −20° C. for 15 s and 3000 rpm in an inert gas atmosphere.

According to certain embodiments, the organic semiconductor materials in a BHJ can each be present as individual powders and optionally also a second scintillator used so that then the mixing can be performed with 3, 4 or more materials. A number of three or more powders would also be conceivable, for example for ternary BHJ or in the case of the addition of additives such as, for example, diiodooctane or crosslinkers such as bifunctional or multifunctional oxirane or oxetane derivatives (so-called monomeric liquid network formers) in order to improve, the electrical or mechanical performance. It is also conceivable for two scintillator powders and one BHJ powder to be mixed together. In this case, the scintillator powders can be of different sizes. The smaller scintillator particles could then fill the interstices of the larger particles thus resulting in the densest possible packing of the parts during compaction during the production of a detection coating.

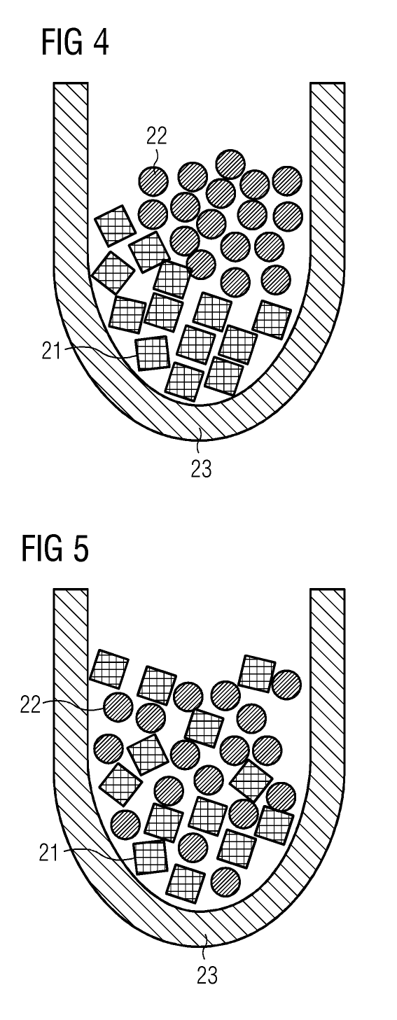

FIGS. 3 to 5 are schematic depictions of an example intermixing process.

FIG. 3 shows by way of example two starting powders prepared in two separate vessels 11: a first vessel 11 contains the scintillator powder 12, i.e. the powder comprising a first scintillator, and a further vessel 11 contains the powder 13 of an organic semiconductor, i.e. a powder comprising organic semiconductor material. In this case, the powder 13 of an organic semiconductor can, for example, form a mixture of at least two organic semiconductors, which together form a bulk heterojunction (BHJ).

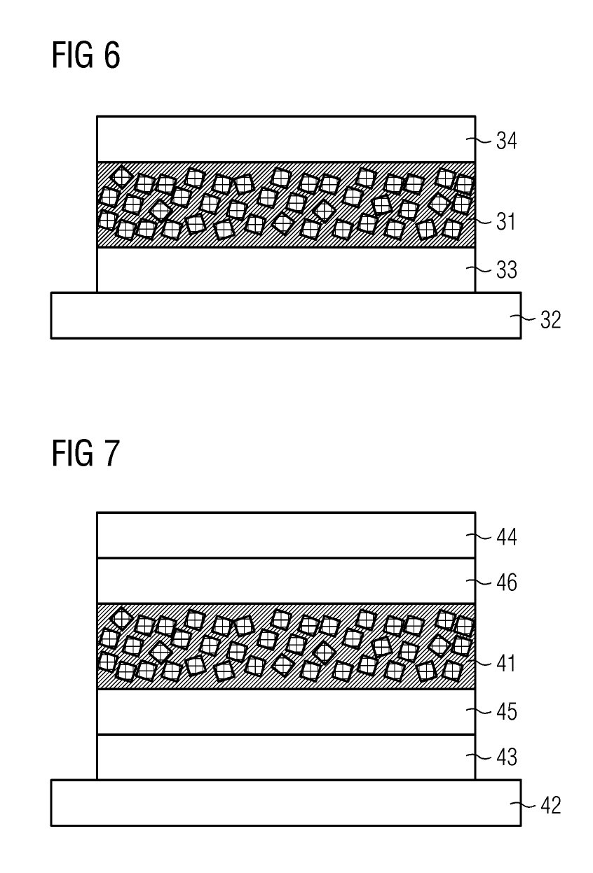

In FIG. 4, the two starting powders are placed in a mixing vessel 23, wherein, here, to differentiate the separate powders, the powders are designated scintillator powder 21 and powder 22 of an organic semiconductor. In this case, FIG. 4 depicts the status before intermixing. Following the intermixing, a homogeneous distribution of the two powders is achieved, such as shown in FIG. 5.

A further embodiment of the invention relates to a method for the production of a detector, in particular an X-ray detector, comprising:

the provision of a substrate comprising a first electrode;

optionally the application of a first intermediate coating;

the application of the powder mixture according to an embodiment of the invention;

optionally the application of a second intermediate coating; and

the application of a second electrode;

wherein the powder mixture according to an embodiment of the invention, optionally with the first intermediate coating and/or the second intermediate coating and/or the second electrode, is compacted, in particular sintered.

In this case, during the compaction of the powder mixture, a detection coating is formed in the detector, in which then radiation such as, for example, gamma radiation and/or X-rays, preferably X-rays, can be detected. Therefore, the detector produced by way of this method is for example a gamma detector and/or an X-ray detector, in particular an X-ray detector.

With the method according to an embodiment of the invention for the production of a detector, the possibility is not excluded that individual layers, such as for example also the detection coating made of the powder mixture according to the invention, are compacted separately and then applied to the respective coating located therebelow—i.e., in the case of the detection coating, the substrate or the first intermediate coating. It is also, for example, possible for the second electrode to be provided as such and then applied, wherein, in this case, this does not have to be compacted. The case can also be similar for the first and/or second intermediate coating.

The substrate comprising the first electrode, the optional first and/or second intermediate coating and the second electrode are not particularly restricted and can be used as suitable depending upon the detector layer, i.e. depending on the powder mixture, and also depending on the radiation to be detected, for example gamma radiation and/or X-rays. For example, it is also possible for the first electrode itself to serve as the substrate.

In this case, the substrate can, for example, comprise a substrate as is usually used in detectors, but can also be a temporary substrate, from which the detector is also removed again. For example, glass and/or plastics can be used as substrates. It is also possible for a substrate to comprise a functional coating or a functional design. For example, thin-film transistors can also be used as substrates, or arrays (matrix) of thin-film transistors (TFT), also known as backplanes. This facilitates the pixelation of a detector such as an X-ray detector. In this case, backplane TFTs are as a rule based on an a-Si, IGZO and other metal oxides or silicon as a CMOS circuit and are not particularly restricted. It is then, for example, in each case possible for a structured contact to be applied to the individual TFTs. A, for example structured, electrode can also be applied directly to a detector layer, for example a hybrid layer, or an intermediate coating and these can then be applied with bonding techniques, such as are known for example from chip-on glass, chip-on foil (bumps). According to certain embodiments, the substrate, for example a backplane, comprises or contains the first, for example lower, electrode.

The electrodes can include electrodes such as those usually used in electronic components, in particular detectors. Electrode materials can, for example, be metals, for example Au, Ag, Pt, Cu, Al, Cr, Mo, etc., or mixtures or alloys thereof, preferably Al, Mo, and Cr, or conductive oxides or metal oxides, for example ITO, AZO, preferably ITO, and/or conductive polymers, for example PEDOT or PEDOT:PSS.

In certain embodiments, the detector according to an embodiment of the invention can contain intermediate layers, so-called interlayers, which improve the transition between the detection coating as an active coating and the respective electrodes as contact layers and hence improve the sensor contacting. These are not particularly restricted and, in the case of the use of a BHJ in the detection coating or the powder mixture according to the invention can, for example, in each case comprise one of the, for example, two, organic semiconductor materials in the BHJ.

As already described above, the provision of a powder mixture according to an embodiment of the invention can achieve a higher content of scintillator in a detection coating in a detector.

This can result is reduced thickness of the detection coating, such is demonstrated below by way of example.

For example, with a accelerating voltage of 70 kV and filtering of 2.5 mm aluminum with GOS as a scintillator, the following layers thicknesses can be achieved in the detection coating, depending upon the volume content of GOS in the detection coating (optionally with GOS particles with different particle sizes to achieve a higher packing density), in order to achieve the same absorption of the radiation:

1) ratio of organic semiconductor material:scintillator=1:4→40 Vol. % GOS in the detection coating→500 μm layer thickness in order to absorb 65% of the X-rays

2) ratio of organic semiconductor material:scintillator=1:12→66 Vol. % GOS in the detection coating→300 μm layer thickness in order to absorb 65% of the X-rays

3) ratio of organic semiconductor material:scintillator=1:32→86 Vol. % GOS in the detection coating→230 μm layer thickness in order to absorb 65% of the X-rays (reduction of layer thickness by more than 50% compared to 1) with 500 μm)

According to certain embodiments for the compaction, sintering, for example soft sintering, is performed at a temperature of between 30 and 300° C., preferably between 50 and 200° C., more preferably between 100 and 150° C. In this case, the temperature range of the sintering can be dependent upon the choice of the organic semiconductor materials used (for example electron and/or hole conductors), the production method for the starting powders and on any solvents that may be present in this process, for example residual solvent from the production of the actual powder such as, for example, during production by precipitation. According to certain embodiments, the sintering removes, or at least substantially removes, any residual solvents that may be present so at that at the most only traces in the ppm range are present.

According to certain embodiments, for the compaction, sintering at is performed at a pressure of between 3 and 500 MPa, preferably between 4 and 200 MPa, more preferably between 5 and 100 MPa. The high pressures enable the particles of the organic semiconductor materials, for example polymers and/or small molecules, to “flow” or be pressed into the cavities between the scintillator particles.

The compaction of the powder mixture by pressure and possibly temperature, for example by sintering, causes the interstices in the detection coating—and possibly further layers—to be minimized and compacted such that, on the application of an electrical voltage, electrical charge transport, for example via hopping or redox process, between the individual molecules of the powder is enabled.

A further embodiment of the invention relates to a detector, in particular an X-ray detector, which is produced by the method according to an embodiment of the invention for the production of a detector.

According to certain embodiments, the detector hence comprises a substrate with a first electrode, optionally a first intermediate coating, a detection coating, which was produced from the powder mixture according to an embodiment of the invention, optionally a second intermediate coating, and a second electrode.

According to certain embodiments, the detector is a pixilated X-ray detector, in particular for imaging purposes.

In this case, in the detector according to an embodiment of the invention, microscopic images enable conclusions to be drawn regarding the production method. While, for example, in the case of precipitated hybrid-organic powders such as core-shell particles, the organic semiconductor material preferably surrounds the scintillator particles, with the method described here, the scintillator particles surround the organic semiconductor material.

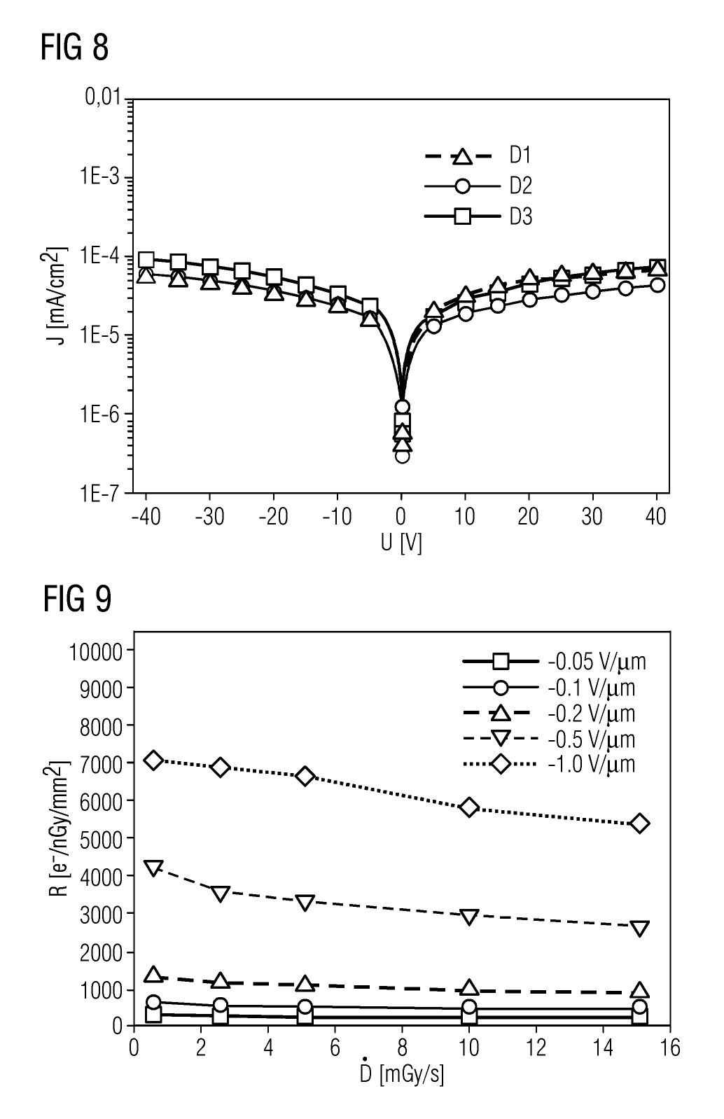

FIGS. 6 and 7 are schematic depictions of example layer sequences of detectors according to embodiments of the inventions, here X-ray detectors.

FIG. 6 is a schematic depiction of the layer structure of an example X-ray detector following soft sintering. A hybrid coating 31 is formed from scintillator particles, which are embedded in a compact matrix of an organic semiconductor material, for example in the form of a BHJ. The hybrid coating 31 is fully compacted and, therefore, does not have any air inclusions. For the complete detector, the hybrid coating 31 is inserted between the first electrode 33, which is applied to substrate 32, and the second electrode 34.

In comparison to FIG. 6, in FIG. 7 two intermediate layers 45, 46 have been introduced into an example X-ray detector with the objective of reducing the dark currents of the organic semiconductor material, for example a photoconductor, in order in this way to increase the dynamic range of the component or detector and hence reduce the dose for the patient. Hence, the structure is as follows: substrate 42; first electrode 43; first intermediate coating 45; hybrid coating 41, in which scintillator particles are embedded in a compacted matrix of organic semiconductor materials; second intermediate coating 46, second electrode 44.

Within reason, the above embodiments, and developments can, be freely combined with one another. Further possible embodiments, developments and implementations of the invention also include combinations not explicitly mentioned of features of the invention which are described above or in the following in relation to the example embodiments. In particular, the person skilled in the art will also add individual aspects as improvements or additions to the respective basic form of the present invention.

### EXAMPLES

The invention will now be described with reference to example embodiments, but is not restricted thereby.

### Example 1

To produce a X-ray detection coating, powder from PCBM and P3HT, both of which have a mean particle size of 40 μm and a maximum particle size of 100 μm, determined by way of scanning electron microscopy, and from GOS with a mean particle size of 1.8 μm, by way of scanning electron microscopy, are mixed in a weight ratio of 1:1:8, based on mixing with a speed mixer after precooling for 15 min at −20° C. for 15 s and 3000 rpm in an inert gas atmosphere.

The mixed powder was applied to a plurality of diodes as a substrate to which an ITO electrode with a thickness of 120 nm had been applied and sintered at 140° C. and a pressure of ˜150 MPa for 15 min. The layer thickness of the hybrid coating obtained in this way was 160 μm and the size was 2.5 cm×2.5 cm. Subsequently, an Al electrode with a thickness of 100 nm was applied and hence bonded to the hybrid coating.

The detector obtained in this way was irradiated with a Megalix II X-ray tube (Siemens) with a W anode at 70 kV and the current-voltage characteristic and the X-ray conversion rate determined.

FIG. 8 shows the current-voltage characteristics of 3 diodes D1 to D3 in the components obtained in this way and FIG. 9 the X-ray conversion rates of diode 1 at different dose rates and applied electrical fields.

In this case, the values obtained in FIGS. 8 and 9 correspond to the values which are obtained with an X-ray detector in which the detection coating is produced with core-shell particles by precipitation with the same parts by weight of PCBM, P3HT and GOS (1:1:8). This production of core-shell particles can be dispensed with in the example detector.

An embodiment of the invention provides a powder mixture which can be used to achieve simple production of effective detection coatings in detectors, for example X-ray detectors, in particular also with an increased content of scintillators in the detection coating. Mixing the individual starting materials in particulate form as powders enables much higher scintillator concentrations to be achieved with a positive effect on the X-ray absorption in the detector layer, for example a hybrid coating.

A higher concentration of scintillator particles in the detection coating for X-rays and/or gamma radiation, for example, an X-ray absorption layer, enables, a higher absorption of radiation with the same layer thickness. This ultimately means that it is possible to make the detection coating thinner in order to ensure the same absorption, for example X-ray absorption. Thinner absorption layers have the advantage that lower operating voltages possible are enabled and simultaneously the path that has to be travelled by the charge carriers to the electrodes can be reduced thus resulting in a reduction in the transit time and a reduction in the charge carrier combination hence to faster detectors and greater efficiency.

In this case, the production of the individual starting materials as powder is much more simple and inexpensive than the production of core-shell particles.

The patent claims of the application are formulation proposals without prejudice for obtaining more extensive patent protection. The applicant reserves the right to claim even further combinations of features previously disclosed only in the description and/or drawings.

References back that are used in dependent claims indicate the further embodiment of the subject matter of the main claim by way of the features of the respective dependent claim; they should not be understood as dispensing with obtaining independent protection of the subject matter for the combinations of features in the referred-back dependent claims. Furthermore, with regard to interpreting the claims, where a feature is concretized in more specific detail in a subordinate claim, it should be assumed that such a restriction is not present in the respective preceding claims.

Since the subject matter of the dependent claims in relation to the prior art on the priority date may form separate and independent inventions, the applicant reserves the right to make them the subject matter of independent claims or divisional declarations. They may furthermore also contain independent inventions which have a configuration that is independent of the subject matters of the preceding dependent claims.

None of the elements recited in the claims are intended to be a means-plus-function element within the meaning of 35 U.S.C. §112(f) unless an element is expressly recited using the phrase “means for” or, in the case of a method claim, using the phrases “operation for” or “step for.”

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

### LIST OF REFERENCE NUMBERS

1 X-ray quantum
2 Semiconductor or scintillator for detection
2a, 2b Electron-hole pair
2′ Low-radiation energy
3 Photodetector
4 Electrode
11 Vessel
12 Scintillator powder
13 Organic semiconductor powder
21 Scintillator powder
22 Organic semiconductor powder
23 Mixing vessel
31 Hybrid coating
32 Substrate
33 First electrode
34 Second electrode
41 Hybrid coating
42 Substrate
43 First electrode
44 Second electrode
45 First intermediate coating
46 Second intermediate coating

What is claimed is:

1. A powder mixture, comprising at least one organic semiconductor material and at least one first scintillator.

2. The powder mixture of claim 1, wherein the organic semiconductor material comprises at least one of an electron conductor and a hole conductor.

3. The powder mixture of claim 1, wherein the organic semiconductor material forms a bulk heterojunction.

4. The powder mixture of claim 1, wherein the first scintillator comprises scintillator particles with an average particle size of 0.5 to 50 μm.

5. The powder mixture of claim 1, wherein the organic semiconductor material comprises particles with an average particle size of 0.5 to 500 μm.

6. The powder mixture of claim 1, wherein the weight ratio of organic semiconductor material to the first scintillator lies within a range of 2:1 to 1:32.

7. The powder mixture of claim 1, wherein the first scintillator is coated with a protective coating.

8. The powder mixture of claim 1, further comprising:
a second scintillator, wherein the second scintillator has an average particle size smaller than the average particle size of the first scintillator.

9. A method for the production of a powder mixture comprising at least one organic semiconductor material and at least one first scintillator, comprising:
provision of at least one powder comprising at least one organic semiconductor material;
provision of at least one powder comprising at least one first scintillator; and
intermixing the at least one powder comprising at least one organic semiconductor material band the at least one powder comprising at least one first scintillator.

10. The method of claim 9, wherein, before the intermixing, at least one of the powder comprising the at least one organic semiconductor material and the powder comprising at least one first scintillator is cooled in an inert gas to a temperature of 0° C. or lower.

11. The method of claim 9, wherein the intermixing is performed for a period of less than 120 s.

12. A method for the production of a detector, comprising:
provision of a substrate including a first electrode;
application of a powder mixture of claim 1; and
application of a second electrode,
wherein the powder mixture of claim 1 is compacted.

13. The method of claim 12, wherein the compacting includes sintering and wherein the sintering is performed at a temperature of between 30 and 300° C.

14. The method of claim 12, wherein the compacting includes sintering and wherein sintering is performed at a pressure of between 3 and 500 MPa.

15. A detector, produced according to a method of claim 12.

16. The powder mixture of claim 2, wherein the organic semiconductor material forms a bulk heterojunction.

17. The powder mixture of claim 4, wherein the first scintillator comprises scintillator particles with an average particle size of 1 to 20 μm.

18. The powder mixture of claim 5, wherein the organic semiconductor material comprises particles with an average particle size of 0.8 to 50 μm.

19. The powder mixture of claim 17, wherein the first scintillator comprises scintillator particles with an average particle size of 1.8 to 10 μm.

20. The powder mixture of claim 18, wherein the organic semiconductor material comprises particles with an average particle size of 1 to 30 μm.

21. The powder mixture of claim 7, wherein the protective coating is at least one of an oxide and nitride coating.

22. The method of claim 10, wherein, before the intermixing, at least one of the powder comprising the at least one organic semiconductor material and the powder comprising at least one first scintillator is cooled in an inert gas to a temperature of −10° C. or lower.

23. The method of claim 22, wherein, before the intermixing, at least one of the powder comprising the at least one organic semiconductor material and the powder comprising at least one first scintillator is cooled in an inert gas to a temperature of −15° C. or lower.

24. The method of claim 11, wherein the intermixing is performed for a period of less than 60 s.

25. The method of claim 24, wherein the intermixing is performed for a period of less than 45 s.

26. The method of claim 10, wherein the intermixing is performed for a period of less than 120 s.

27. The method of claim 26, wherein the intermixing is performed for a period of less than 60 s.

28. The method of claim 27, wherein the intermixing is performed for a period of less than 45 s.

29. The method of claim 12, wherein a first intermediate coating and a second intermediate coating are applied.

30. The method of claim 13, wherein the sintering is performed at a temperature of between 50 and 200° C.

31. The method of claim 30, wherein the sintering is performed at a temperature of between 100 and 150° C.

32. The method of claim 29, wherein the compacting includes sintering and wherein the sintering is performed at a temperature of between 30 and 300° C.

33. The method of claim 32, wherein the sintering is performed at a temperature of between 50 and 200° C.

34. The method of claim 33, wherein the sintering is performed at a temperature of between 100 and 150° C.

35. The method of claim 13, wherein the compacting includes sintering and wherein sintering is performed at a pressure of between 5 and 100 MPa.

36. The method of claim 29, wherein the compacting includes sintering and wherein sintering is performed at a pressure of between 3 and 500 MPa.

37. The method of claim 36, wherein the compacting includes sintering and wherein sintering is performed at a pressure of between 5 and 100 MPa.

38. A detector, produced according to a method of claim 29.
